(19) United States
(12) Patent Application Publication
(10) Pub. No.: US 2005/0233853 A1
(43) Pub. Date: Oct. 20, 2005

(54) Cometary gears output rotary engine

(76) Inventor: Yongsak Suebsinskuichai, Bangkok (TH)

Correspondence Address: RUJIRA SRISUTHEP, 369 Brookwood Drive, Winston-Salem, NC, 27127, US

(21) Appl. No.: 11/077,245

(22) Filed: Mar. 10, 2005

(30) Foreign Application Priority Data
Apr. 19, 2004 (TH) 090223

(51) Int. Cl. F16H 23/00

(52) U.S. Cl. 475/163

(57) ABSTRACT

The Cometary Gears Output Rotary Engine (CGORE) has been developed from the Rotary Piston Engine. The Cometary Gears Set (CGS) output shaft replaces the traditional eccentric shaft. The CGORE has significantly better performance than the original or traditional rotary piston engine. The CGS has 3 gears fitting uniquely together. The CGORE has two systems of output shaft, one fixed at Internal Gear (No. 4) and the other fixed at External Gear (No, 6). When the rotor, rotated by the expansion of ignited gas, the power transmitted through the gears set converts the force obtained from the rotor into torque with higher efficiency than the eccentric shaft. As a result, the rotary piston engine with the Cometary Gears Set produces significantly higher efficiency of output torque, quiet operation, low fuel consumption, low exhaust gas temperature and reduces overall wear and tear of the engine. These advantages and the potential of the engines (CGORE) usage, resulting in the reduction of environmental pollutants, will warrant great success.

### PRIOR ART DESCRIPTION

The rotary piston engine was invented by Mr. Felix Wankel, a German inventor around 1954. It was also called Wankel rotary engine. The inventor and the Audi/NSU Company registered the rotary piston engine patent in several countries, the patent right had expired in 1981 more than 24 years ago.

The first car with the rotary engine was sold by Mazda in 1967. Many leading car manufacturers bought the patent right from Audi/NSU for further research and development for their production. By 1975-1976 all of them except Mazda has shut down the project, and Audi/NSU had terminated the production of the rotary piston engine in the Ro80 cars. This actions indicated that the original rotary piston engine had a ‘big problem’.

### BACKGROUND OF THE INVENTION

The rotary piston engine, when compared to the conventional reciprocating engine, has several disadvantages. The drawbacks are: low output torque, high fuel consumption, and high exhaust gas temperature.

The main factor of the situation is the inefficiency of power transmitted from the rotor to the eccentric (output) shaft.

This invention is set out to improve the efficiency of power transmission by designing and replacing the traditional eccentric (output) shaft with a new set of gears called “the Cometary Gears Set” and the method for attaching the Cometary Gears Set output shaft to Wankel engine and other rotary piston engines.

What is the Cometary Gears Set (CGS)? The CGS consists of gears that rotate like comets traveling from outer space around the sun and then returned to their places in the universe.

The CGS consists of three parts of gear, one internal gear (No. 4), one ring gear (No. 5), and one external gear (No. 6). The ring gear has two rows of gear, the outer ring and the inner ring. The outer ring gear (No. 5) engaged to the internal gear (No. 4). The inner ring gear (No. 5) engaged to the external gear (No. 6). The ratio of External gear:Ring gear:Internal gear are 2:3:4 respectively, and the common factor of this system is 15, 17 or 19 and the eccentric distance is 1.2 to 1.5 centimeters

With the rotary piston engine transmitted by means of the CGS output shaft, there are two systems of output.

System I. Fixed internal gear (big gear, No. 4). The internal gear (No. 4) drives the ring gear (No. 5) and the sun gear (or external, No. 6) is driven. The ratio of the output shaft is 3 times of the rotor revolution, as shown in drawing FIG. 1.

System II. Fixed external gear (sun gear, No. 6). The external gear (No. 6) drives the ring gear (No. 5) and the big gear (or internal, No. 4) is driven. The ratio of output shaft is 1.5 time of the rotor revolution, as shown in drawing FIG. 2.

Single rotor engine in System I. Fixed internal gear (No. 4). The main components are shown in drawing FIG. 3.
Rotor housing (No. 1),
Side housing (No. 2), front and rear.
Rotor (No. 3), which is equipped with two ring gears, the inner ring gear (No. 5) fixed to one side, and the outer ring gear (No. 5) fixed to the other side of the rotor.
The Cometary Gears Set is, the internal gear (No. 4) fixed in the front side housing (No. 2), engaged to the outer ring gear (No. 5) side of the rotor. The sun gear (No. 6) mounted on the output shaft, engaged to the inner ring gear (No. 5) side of the rotor, to form the Cometary Gears Set on the main output shaft (No. 9).

Two Rotors Engine in System I. Fixed internal gear (No. 4). The main components are shown in drawing FIG. 4.
Two rotor housings (No. 1)
Two rotors (No. 3)
Two side housings (No. 2) front and rear.
One intermediate housing or gear housing (No. 7)
The Cometary Gears Set, both internal gears (No. 4) fixed in each side of the intermediate housing (gear housing, No. 7), and engaged to each side of the outer ring gears (No. 5) of rotors. The external gear or sun gear (No. 6), mounted in front and rear on the output shaft (No. 9) and engaged to each side of the inner ring gears (No. 5) of rotors, to form two sets of the CGS on the main output shaft (No. 9) next to the flywheel in the rear side of the engine.

Single Rotor Engine in System II. The main components are shown in drawing FIG. 5. The components (No 1, 2, and 3), are the same as in single rotor engine in System I, except an external gear (sun gear, No. 6) fixed in the front side housing (No. 2) engaged to an inner ring gear (No. 5) side of rotor. The internal gear (No. 4) mounted on the output shaft (No. 9) engaged to the outer ring gear (No. 5) side of rotor to form the Cometary Gears Set on the main output shaft (No. 9) next to the flywheel in the rear side of engine.

Two Rotors Engine in System II. The main components are shown in drawing FIG. 6. The components (No 1, 2, and 3) are the same as in System I except the external gears (sun gears, No. 6) fixed in both sides of the intermediate housing (No. 7) and engaged to the inner ring gears (No. 5) side of rotors. The internal gears (No. 4) mounted on the output shaft (No. 9), engaged to the outer ring gears (No. 5) side of the rotors, to form the two Cometary Gears Set on the main output shaft (No. 9) and next to the flywheel in the rear side of the engine.

By calculation, the rotary piston engine when equipped with the Cometary Gears Set output shaft, produces more than double the output torque or more than 100% higher than the original rotary engine at the same speed (in System I); and more than 200% higher (or 4 times) at 1.5 times the piston speed (in System II).

Because of the higher torque output, the new Cometary Gears Output Rotary Engine can also be transmitted with the conventional manual gear transmission.

### SUMMARY OF THE INVENTION

The Inventor invented a model of the Cometary Gears Set, and how it can be operated. The Cometary Gears Set rotates in motion similar to the eccentric shaft except direction.

The Cometary Gears Set is a series of three gears driving each other to provide smoother power while being lighter in weight. The Cometary Gears Output Rotary Engine has two systems of output shaft and can be operated in 2-stroke or 4-stroke engine in Otto or Diesel cycle.

In System I, the ratio of the output shaft is triple of the rotor revolution. In System II, in the mean time, the ratio of output shaft is one and one-half times that of the rotor revolution.

The Inventor also invented an apparatus to test the efficiency of transmission by means of the eccentric shaft and the Cometary Gears Set output shaft.

The advantages of the rotary piston engine itself (i.e., no reciprocating motion, no heavy flywheel and no valve character) combined with the high performance transmitted by the CGS, the CGORE are significant. With the enhanced power weight ratio of the CGORE, a higher speed can be reached with less vibration, reduced fuel consumption, and lower noise level. Lead-free gasoline and liquefied natural gas can be utilized. As the result, of the Otto cycle or the Diesel cycle, the engines have high thermal efficiency. After more than 40 years of minimal success of the original rotary piston engine with eccentric shaft, the new CGORE will achieve maximum success.

### DESCRIPTION OF DRAWINGS

FIG. 1. Cross section of the Cometary Gears Set output shaft. No. 4, 5, and 6, to form the CGS. In System I, the internal gear (big gear, No 4) fixed to the housing (No. 2), and sun gear (No. 6) mounted on the output shaft (No 9).

FIG. 2. Cross section of the Cometary Gears Set output shaft. No. 4, 5, and 6, to form the CGS. In System II, the sun gear (No. 6) fixed to the housing (No. 2) and the big gear (No. 4) mounted on the output shaft (No. 9).

FIG. 3. Longitudinal section of Single Rotor CGORE, the internal gear (No. 4) fixed to the front housing (No. 2) in System I. The sun gear (No. 6) mounted on the output shaft (No. 9) on the rear side of the engine.

FIG. 4. Longitudinal section of the Two Rotor CGORE, the two internal gears (No. 4) fixed in the intermediate housing (No. 7), and the two sun gears (No. 6) mounted on the output shaft (No. 9) in the front side (No. 2) and the rear side (No. 2) of the engine.

FIG. 5. Longitudinal section of Single Rotor CGORE, the sun gear (No. 6) fixed in the front housing (No. 2) in System II and the big gear (No. 4) mounted on the output shaft (No. 9) on the rear side of the engine.

FIG. 6. Longitudinal section of the Two Rotors CGORE, the sun gears (No. 6) fixed to the intermediate housing (No. 7) in System II on both sides. The two big gears (No. 4) mounted on the output shaft (No. 9) at the front and rear side of the engine.

The main components of the Cometary Gears Output Rotary Engine. 1. Rotor, 2. Side housing (front & rear), 3. Rotor, 4. Internal gear (big gear), 5. Ring gear (two rows of gears), 6. External gear (sun gear), 7. Intermediate housing (gear housing), 8. Eccentric spacer, 9. Main output shaft, 10. Main bearing, 11. Rotor bearing, hollow shaft bearing, 12. Starting wheel, 13. Flywheel, 14. Inlet port, 15. Exhaust port, 16. Spark plug, 17. Apex seal, 18. Spacer wheel, 19. Side spacer, 20. No. 4, 5 and 6 form the Cometary Gears Set.

1. The Cometary Gears Set consists of three parts of gear (No 4, 5, 6): One external gear (No. 6), one ring gear (No. 5), and one internal gear (No. 4). The ring gear (No. 5) has two rows of gear, the outer ring gear (No. 5) and the inner ring gear (No. 5). The outer ring gear (No. 5) engaged to the internal gear (No. 4), and the inner ring gear (No. 5) engaged to the external gear (No. 6). The ratio of external gear to the ring gear and the internal gear are 2:3:4 respectively, and the common factor of gear is 15 or 17 or 19, and the eccentric distance is 1.2 to 1.5 centimeters.

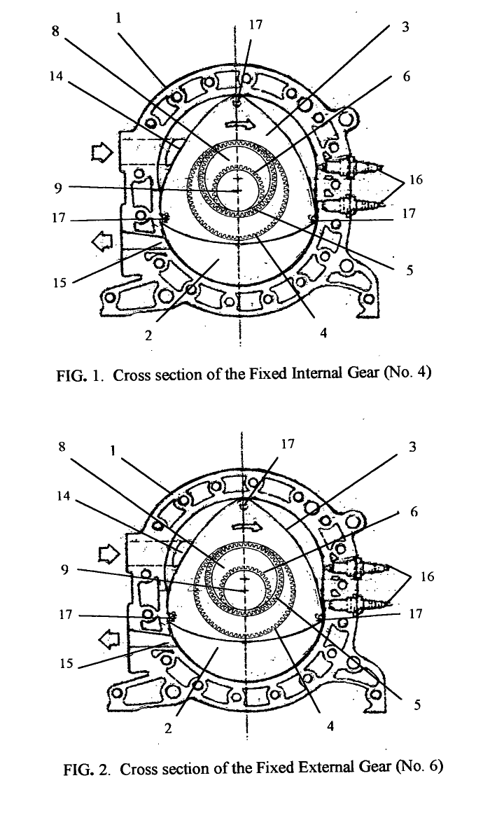

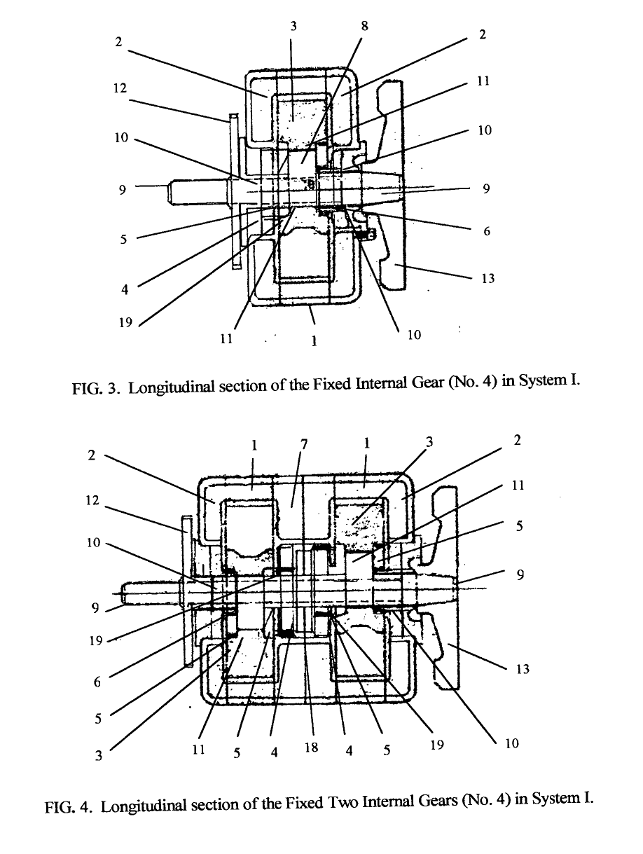

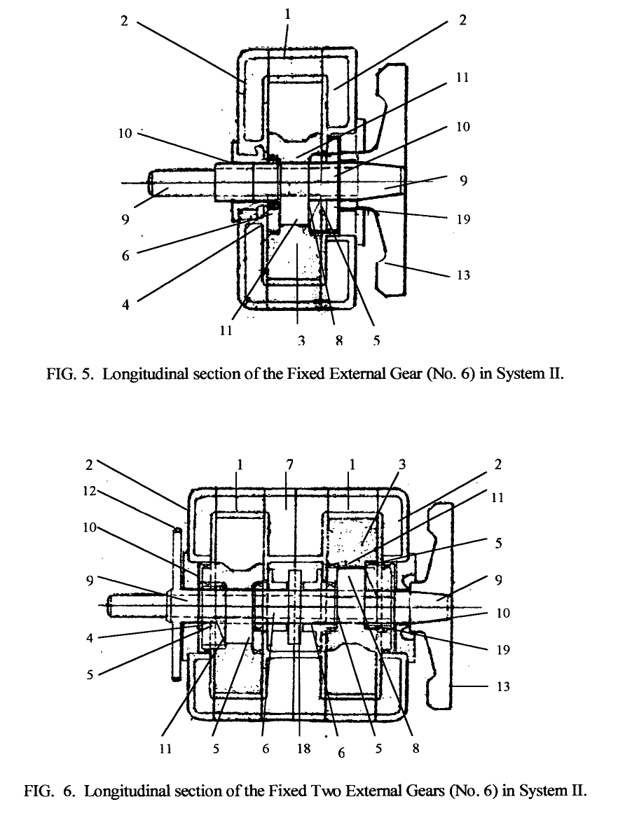

2. According to claims 1, the Cometary Gears Output Rotary Engine has two systems of output shaft. System I. (FIG. 1). Fixed internal gear (No. 4) in housing (front, middle or rear) engaged to the outer ring gear (No. 5) side of rotor, and the external gear (No. 6) mounted on the output shaft (No. 9). System II. (FIG. 2). Fixed external gear (No. 6) in housing (front, middle or rear) engaged to the inner ring gear (No. 5) side of rotor, and the internal gear (No. 5) mounted on the output shaft (No. 9). The Cometary Gears Output Rotary Engine can operate with 2-stroke or 4-stroke in Otto cycle or Diesel cycle.
